(19) United States
(12) Patent Application Publication
(10) Pub. No.: US 2026/0164141 A1
(43) Pub. Date: Jun. 11, 2026

(54) APPARATUS AND SYSTEM

(71) Applicant: CANON KABUSHIKI KAISHA, Tokyo (JP)

(72) Inventor: KATSURO TAKENAKA, Saitama (JP)

(21) Appl. No.: 19/183,405

(22) Filed: Apr. 18, 2025

(30) Foreign Application Priority Data
Apr. 23, 2024 (JP) 2024-070114

(51) Int. Cl. H04N 25/30; G01T 1/17; H04N 25/42; H04N 25/63; H04N 25/78

(52) U.S. Cl. CPC H04N 25/30; G01T 1/17; H04N 25/42; H04N 25/63; H04N 25/78

(57) ABSTRACT

An apparatus includes a reading unit configured to read a charge accumulated in a conversion element, and a generation unit configured to generate image data, wherein a first correction signal is generated by reading a charge accumulated in the conversion element during a first reading time before transmission of a permission signal, a radiation signal is generated by reading a charge accumulated in the conversion element based on emission of radiation after the transmission of the permission signal, a second correction signal is generated by reading a charge accumulated in the conversion element not based on the emission of the radiation during a second reading time after the transmission of the permission signal, image data is generated by performing a correction process on the radiation signal using the first or second correction signal, and the second reading time is shorter than the first reading time.

### BACKGROUND

### Technical Field

The aspect of the embodiments relates to an apparatus and a system.

### Description of the Related Art

As a radiation imaging apparatus that captures a radiation image using radiation (e.g., an X-ray) passing through an object, a radiation imaging apparatus capable of displaying a radiation image in real time is prevalent. A radiation imaging apparatus that uses a flat-panel detector (FPD) is also discussed. In the FPD, minute radiation detectors, each obtained by laminating a solid photodetector, in which an amorphous semiconductor is sandwiched between a transparent conducting film and a conducting film, and a scintillator that converts radiation into visible light, are arranged in a matrix on a quartz glass substrate. A solid photodetector that uses a photodetector such as a charge-coupled device (CCD) or a complementary metal-oxide-semiconductor (CMOS) is also known. A radiation detector that causes a solid photodetector to directly detect radiation without using a scintillator is also known. The FPD detects the dose of radiation emitted during any accumulation time as the amount of charges. Thus, when a radiation image of an object is captured, and if a charge unrelated to the emission of radiation is present in any of the radiation detectors, the charge is superimposed as noise on the radiation image and causes a decrease in the image quality of the radiation image. For example, as an example of the charge as noise, there is a residual charge (an afterimage) that remains based on the characteristics of the solid photodetector or the scintillator after the capturing of a radiation image captured in advance. As another example of the charge as noise, there is a dark current due to a charge generated by the solid photodetector mainly under the influence of temperature. Additionally, the image quality of the radiation image also decreases due to fixed noise caused by a defect specific to each of the radiation detectors. When a radiation image of an object is captured, a residual charge or a charge of a dark current component is also accumulated in proportion to the accumulation time of an image for which radiation is emitted. Thus, the image quality of the radiation image decreases. Thus, in the capturing of a radiation image of an object, an offset correction process for correcting offset components due to a residual charge and a dark current charge accumulated during the capturing and fixed noise is performed. Generally, the offset correction process is performed by using image data acquired by capturing an image in the state where radiation is not emitted (non-exposure image data) as an offset correction image, and subtracting the offset correction image from a radiation image.

There are multiple methods of such offset correction.

Japanese Patent Application Laid-Open No. 2018-157939 discusses (1) an intermittent dark method for alternately performing the capturing of a radiation image of an object and the acquisition of non-exposure image data (offset correction data) and subtracting the offset correction data from the radiation image. In the following description, this method will occasionally be referred to as “intermittent offset correction”. Japanese Patent Application Laid-Open No. 2018-157939 also discusses (2) a fixed dark method for performing an offset correction process by subtracting non-exposure image data acquired before the capturing of a radiation image of an object as offset correction data from the radiation image. In the following description, this method will occasionally be referred to as “fixed offset correction”. The features of the methods in (1) and (2) are as follows. In the method in (1), since the capturing of a radiation image of an object and the acquisition of non-exposure image data (offset correction data) are alternately performed, it is possible to reduce an afterimage. The method in (1), however, has an issue where the frame rate is low.

On the other hand, in the method in (2), since offset correction data is acquired before the capturing of a radiation image of an object, the frame rate is high, and high-speed continuous imaging such as moving image capturing can be performed. Moreover, imaging with a low dose can be performed, and therefore, a signal-to-noise ratio (SNR) is high. The method in (2), however, has an issue where an afterimage cannot be sufficiently reduced. Moreover, a dark current charge accumulated during imaging changes under the influence of the temperature of a radiation detector, the imaging condition, or the deterioration over time of a sensor. Thus, in a case where offset correction data is acquired before the capturing of a radiation image of an object as in the method in (2), there is an issue where the accuracy of the offset correction process cannot be sufficiently obtained. As described above, since each offset correction method has a feature, it is desirable to select an offset correction method based on the imaging skill.

The offset correction techniques of the intermittent dark method (hereinafter, an “intermittent offset correction mode”) and the fixed dark method (hereinafter, a “fixed offset correction mode”) discussed in Japanese Patent Application Laid-Open No. 2018-157939 have room for improvement in terms of the optimization of the correction methods.

### SUMMARY

According to an aspect of the embodiments, an apparatus includes a conversion element configured to accumulate a charge for generating an image, a communication unit configured to transmit, to an external apparatus, a permission signal permitting emission of radiation, a reading unit configured to read the charge accumulated in the conversion element and generate a signal, and a generation unit configured to generate image data from the generated signal, wherein the reading unit generates a first correction signal by reading a charge accumulated in the conversion element during a first reading time before transmission of the permission signal, generates a radiation signal by reading a charge accumulated in the conversion element based on the emission of the radiation after the transmission of the permission signal, and generates a second correction signal by reading a charge accumulated in the conversion element not based on the emission of the radiation during a second reading time after the transmission of the permission signal, wherein the generation unit generates image data by performing a correction process on the radiation signal using the first or second correction signal, and wherein the second reading time is shorter than the first reading time.

Further features of the disclosure will become apparent from the following description of exemplary embodiments with reference to the attached drawings.

### BRIEF DESCRIPTION OF THE DRAWINGS

FIG. 1 is a block diagram illustrating an example of a configuration of a radiation imaging system according to an exemplary embodiment.

FIG. 2 is an equivalent circuit diagram illustrating an example of a configuration of a radiation detection panel according to the exemplary embodiment.

FIG. 3 is a schematic diagram illustrating an example of a structure of a pixel according to the exemplary embodiment.

FIG. 4 is a diagram illustrating imaging modes according to the exemplary embodiment.

FIG. 5 is a diagram illustrating an example of an operation of the radiation imaging system according to the exemplary embodiment.

FIG. 6 is a diagram illustrating an example of an operation of the radiation imaging system according to the exemplary embodiment.

FIGS. 7A and 7B are diagrams illustrating reading of the radiation imaging system according to the exemplary embodiment.

FIGS. 8A and 8B are diagrams illustrating a temperature characteristic of the radiation imaging system according to the exemplary embodiment.

FIG. 9 is a diagram illustrating an example of an operation of the radiation imaging system according to the exemplary embodiment.

### DESCRIPTION OF THE EMBODIMENTS

Exemplary embodiments will be described in detail below with reference to the attached drawings. The following exemplary embodiments do not limit the disclosure according to the appended claims. Although a plurality of features is described in the exemplary embodiments, not all the plurality of features is essential for the disclosure, and the plurality of features may be combined in any suitable manner. Further, in the attached drawings, the same or similar components are designated by the same reference numbers, and are not redundantly described.

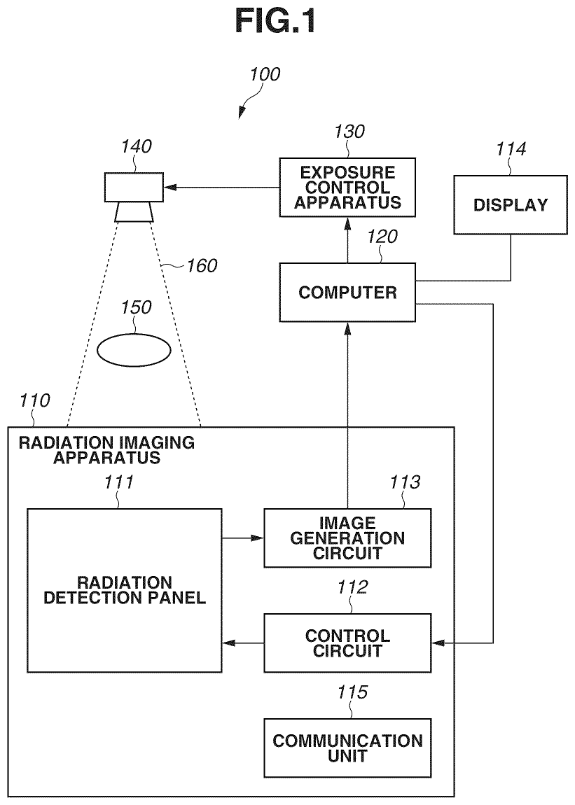

FIG. 1 illustrates an example of the configuration of a radiation imaging system 100 according to an exemplary embodiment. The radiation imaging system 100 is configured to electrically capture an optical image formed by radiation, thereby generating an electrical radiation image. The radiation is typically an X-ray, but may be an α-ray, a β-ray, or a γ-ray. For example, the radiation imaging system 100 includes a radiation imaging apparatus 110 and a computer 120 as a control apparatus that controls the system. The computer 120 as the control apparatus acquires radiation image data from the radiation imaging apparatus 110 and performs image processing on the radiation image data, and thereby can generate a radiation image. In the present exemplary embodiment, the radiation imaging system 100 further includes a display 114 that displays the radiation image generated by the computer 120, an exposure control apparatus 130, and a radiation generating apparatus 140.

According to an exposure command (an emission command) from the exposure control apparatus 130, the radiation generating apparatus 140 starts emitting radiation 160. The radiation 160 emitted from the radiation generating apparatus 140 passes through an object 150 and is incident on the radiation imaging apparatus 110. According to a stop command from the exposure control apparatus 130, the radiation generating apparatus 140 also stops emitting the radiation 160.

The radiation imaging apparatus 110 includes a radiation detection panel 111, a control circuit 112, an image generation circuit (image generation unit) 113, and a communication unit 115. The radiation detection panel 111 generates a radiation image signal according to the radiation 160 incident on the radiation imaging apparatus 110. The radiation image signal is subjected to offset correction by the image generation circuit 113, whereby radiation image data is generated. Then, the radiation image data is transmitted to the computer 120. The control circuit 112 controls the operation of the radiation detection panel 111. For example, based on the preparation status of the radiation detection panel 111, the control circuit 112 generates a permission signal permitting the emission of the radiation 160. Based on a signal obtained from the radiation detection panel 111, the control circuit 112 also generates a stop signal for stopping the emission of the radiation 160 from the radiation generating apparatus 140. The permission signal or the stop signal is supplied (transmitted) from the communication unit 115 to the exposure control apparatus 130 as an external apparatus. In response to the permission signal or the stop signal, the exposure control apparatus 130 sends an emission command or a stop command to the radiation generating apparatus 140. The transmission destination of the permission signal or the stop signal from the communication unit 115 can also be the computer 120, and the computer 120 can also transmit the permission signal or the stop signal to the exposure control apparatus 130. In this case, the exposure control apparatus 130 and the computer 120 may also be collectively considered as an external apparatus.

For example, the control circuit 112 may be composed of a dedicated circuit such as a field-programmable gate array (FPGA) or an application-specific integrated circuit (ASIC). FPGA is the abbreviation of field-programmable gate array, and ASIC is the abbreviation of application-specific integrated circuit. Alternatively, the control circuit 112 may be composed of the combination of a general-purpose processing circuit such as a processor and a storage circuit such as a memory.

In this case, the function of the control circuit 112 may be achieved by the general-purpose processing circuit executing a program stored in the storage circuit.

The image generation circuit 113 as the image generation unit stores a signal supplied from the radiation detection panel 111 in a memory and generates radiation image data based on this signal. The details of the method for generating the radiation image data will be described below. The image generation circuit 113 causes the communication unit 115 to transmit the generated radiation image data to the computer 120.

The computer 120 includes a control unit that controls the radiation imaging apparatus 110 and the exposure control apparatus 130, and a reception unit that receives radiation image data from the radiation imaging apparatus 110. The computer 120 also includes a signal processing unit that processes the radiation image data obtained by the radiation imaging apparatus 110. For example, the signal processing unit performs image processing on the acquired radiation image data, thereby generating a radiation image. Similarly to the control circuit 112, each of the control unit, the reception unit, and the signal processing unit may be composed of a dedicated circuit, or may be composed of the combination of a general-purpose processing circuit and a storage circuit. As an example, the exposure control apparatus 130 includes an exposure switch. If a user turns on the exposure switch, the exposure control apparatus 130 sends an exposure command to the radiation generating apparatus 140 and also sends an emission start request to request the start of the emission of the radiation 160 to the computer 120. In response to the start request, the computer 120 having received the start request notifies the control circuit 112 in the radiation imaging apparatus 110 of the start request to start the emission of the radiation 160. According to the preparation status of the radiation detection panel 111, the control circuit 112 transmits (returns) an emission permission signal to the computer 120 or the exposure control apparatus 130 via the communication unit 115. If the exposure control apparatus 130 and the computer 120 are not synchronously connected together, the radiation detection panel 111 may detect the start of the emission of the radiation 160 based on a pixel signal.

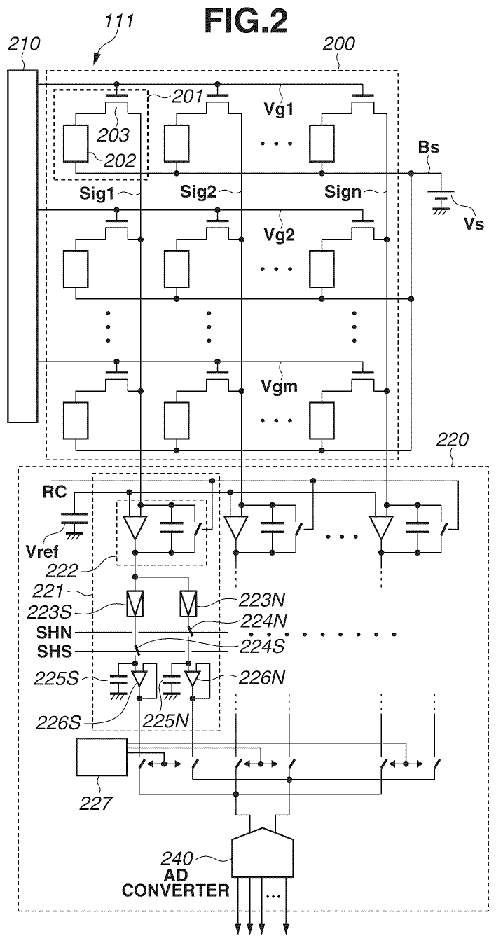

FIG. 2 illustrates an example of the configuration of the radiation detection panel 111. For example, the radiation detection panel 111 includes a pixel array 200, a driving circuit 210 as a driving unit, and a reading circuit 220 as a reading unit. The driving circuit 210 and the reading circuit 220 function as peripheral circuits of the pixel array 200. For example, the pixel array 200 includes a plurality of pixels 201, a plurality of driving lines Vg1 to Vgm, a plurality of signal lines Sig1 to Sign, and a bias line Bs.

The driving lines Vg1 to Vgm are collectively referred to as a “driving line Vg”. The signal lines Sig1 to Sign are collectively referred to as a “signal line Sig”. The plurality of pixels 201 is placed to form a plurality of pixel rows and a plurality of pixel columns. A “pixel row” refers to a set of a plurality of pixels arranged in the horizontal direction in FIG. 2. A “pixel column” refers to a set of a plurality of pixels arranged in the vertical direction in FIG. 2. As an example, the radiation detection panel 111 has a size of 17 inches, and the pixel array 200 has about 3000 pixel rows and about 3000 pixel columns.

The pixel rows of the pixel array 200 are referred to as a “first row” to an “m-th row” (m is an integer greater than or equal to 1) in order from the upper side of FIG. 2. The pixel columns of the pixel array 200 are referred to as a “first column” to an “n-th column” (n is an integer greater than or equal to 1) in order from the left side of FIG. 2. Each pixel 201 is composed of the combination of a single conversion element 202 and a single switch element 203. In the pixel array 200, a pixel 201 located in an i-th row and a j-th column is represented as a “pixel 201(i,j)”. The conversion element 202 and the switch element 203 included in the pixel 201(i,j) are represented as a “conversion element 202(i,j)” and a “switch element 203(i,j)”, respectively. For example, a pixel 201(1,2) represents a pixel 201 located in the first row and the second column.

The conversion element 202 generates a charge according to radiation incident on the pixel 201 and accumulates the charge. In other words, the conversion element 202 can accumulate a charge for generating a radiation image. The conversion element 202 can accumulate not only a charge according to radiation, but also a charge generated by a dark current. That the conversion element 202 of the pixel 201 generates and accumulates a charge is represented as “the pixel 201 generates and accumulates a charge”.

The switch element 203 is connected between the conversion element 202 and the signal line Sig corresponding to the conversion element 202. For example, switch elements 203(1,1) to 203(m,1) are connected between a plurality of conversion elements 202(1,1) to 202(m,1) and the signal line Sig1. If the switch element 203 enters an on state, the conversion element 202 and the signal line Sig enter a conducting state, and a charge obtained by the conversion element 202 (e.g., a charge accumulated in the conversion element 202) is transferred to the signal line Sig. For example, the conversion element 202 may be a metal-insulator-semiconductor (MIS) photodiode placed on an insulating substrate such as a glass substrate and having amorphous silicon as a main material. Alternatively, the conversion element 202 may be a PIN photodiode. The conversion element 202 may be configured as a direct type that directly converts radiation into a charge, or may be configured as an indirect type that converts radiation into light and then detects the light. In the indirect type, a scintillator may be shared by the plurality of pixels 201.

For example, the switch element 203 includes a transistor such as a thin-film transistor (TFT) having a control terminal (a gate) and two main terminals (a source and a drain). In this case, one of the main terminals of the switch element 203 is connected to the conversion element 202, and the other main terminal of the switch element 203 is connected to the reading circuit 220 as the reading unit via the signal line Sig. The conversion element 202 has two main electrodes. One of the main electrodes of the conversion element 202 is connected to one of the two main terminals of the switch element 203, and the other main electrode of the conversion element 202 is connected to a bias power supply Vs via the common bias line Bs. The bias power supply Vs generates a bias voltage.

The control terminal of the switch element 203 of each of the pixels 201 in the first row is connected to the driving line Vg1. The control terminal of the switch element 203 of each of the pixels 201 in the second row is connected to the driving line Vg2. The same applies to the third to m-th rows.

According to a driving signal supplied from the control circuit 112, the driving circuit 210 as the driving unit supplies a driving signal to the control terminal of the switch element 203 of each pixel 201 via the driving line Vg. The driving signal includes an on signal (a voltage at a high level in the following description) for bringing the switch element 203 into an on state, and an off signal (a voltage at a low level in the following description) for bringing the switch element 203 into an off state. For example, the driving circuit 210 includes a shift register. According to a control signal (e.g., a clock signal) supplied from the control circuit 112, the shift register executes a shift operation.

That an on signal (i.e., a driving signal at the high level) is supplied to the pixel 201 is represented as “the pixel 201 is selected”. More specifically, a driving signal is a signal for selecting any of the plurality of pixels 201. The same driving signal is supplied to a plurality of pixels 201 included in the same pixel row. That a plurality of pixels 201 included in a single pixel row is selected is represented as “this pixel row is selected”.

The reading circuit 220 as the reading unit amplifies and reads a signal that appears on the signal line Sig by selecting the pixel 201. This signal is based on a charge accumulated in the conversion element 202. That a signal based on a charge accumulated in the conversion element 202 of the pixel 201 is read is represented as “a signal based on a charge accumulated in the pixel 201 is read”.

The reading circuit 220 includes a single amplification circuit 221 with respect to each signal line Sig. Since the pixel array 200 includes the n signal lines Sig in the example of FIG. 2, the reading circuit 220 includes n amplification circuits 221. For example, the amplification circuit 221 includes an integrating amplification circuit 222, a low-pass filter (LPF) circuit 223S, an LPF circuit 223N, a switch element 224S, a switch element 224N, a capacitor 225S, a capacitor 225N, a buffer circuit 226S, and a buffer circuit 226N. The switch element 224S and the capacitor 225S form a signal sample and hold circuit, and the switch element 224N and the capacitor 225N form a noise sample and hold circuit. The integrating amplification circuit 222 converts a charge accumulated in each conversion element 202 into a voltage signal, and for example, includes an operational amplifier, and an integrating capacitor and a reset switch connected in parallel between an inverting input terminal and an output terminal of the operational amplifier. To a non-inverting input terminal of the operational amplifier, a reference voltage is supplied from a reference power supply Vref. If the reset switch is turned on according to a control signal RC (a reset pulse) supplied from the control circuit 112, the integrating capacitor is reset, and the potential of the signal line Sig is also reset to a reference potential. The LPF circuits 223S and 223N remove noise from a signal from the integrating amplification circuit 222 based on set filter values. The sample and hold circuits hold a voltage signal generated by the integrating amplification circuit 222 and sample-hold signals from the LPF circuits 223S and 223N. The turning on and off of the switch elements 224S and 224N forming the sample and hold circuits is controlled by a control signal SHS and a control signal SHN, respectively, supplied from the control circuit 112. The buffer circuits 226S and 226N buffer (convert the impedances of) signals from the sample and hold circuits and output the signals.

The reading circuit 220 also includes a multiplexer 227 that selects and outputs signals from the plurality of amplification circuits 221 in a predetermined order. For example, the multiplexer 227 includes a shift register. According to a control signal (e.g., a clock signal) supplied from the control circuit 112, the shift register executes a shift operation. By the shift operation, a single signal from the plurality of amplification circuits 221 is selected.

An analog-to-digital (AD) converter 240 converts an analog signal output from the multiplexer 227 into a digital signal. The output of the AD converter 240, i.e., a pixel signal (a radiation signal or a correction signal), is transmitted to the computer 120.

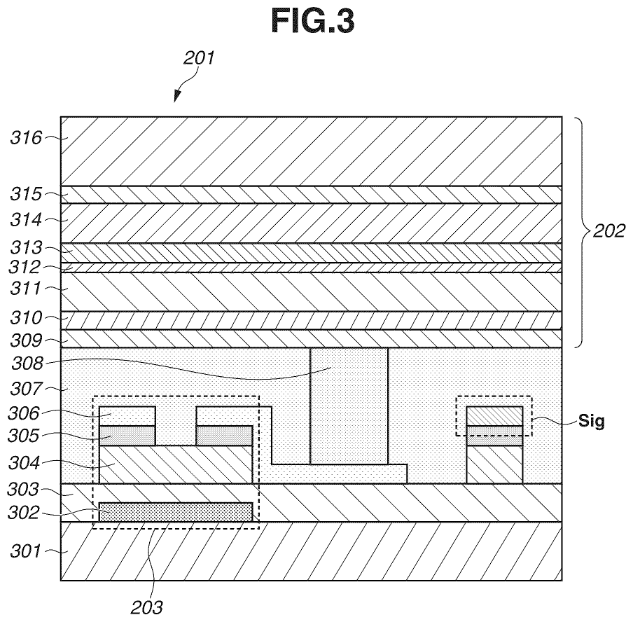

FIG. 3 schematically illustrates an example of the cross-sectional structure of a single pixel 201. The pixel 201 is formed on an insulating substrate 301 such as a glass substrate. The pixel 201 includes a conductive layer 302, an insulating layer 303, a semiconductor layer 304, an impurity semiconductor layer 305, and a conductive layer 306 on the insulating substrate 301. The conductive layer 302 forms the gate of the transistor (e.g., a TFT) included in the switch element 203. The insulating layer 303 is placed to cover the conductive layer 302. The semiconductor layer 304 is placed through the insulating layer 303 on a portion of the conductive layer 302 that forms the gate. The impurity semiconductor layer 305 is placed on the semiconductor layer 304 to form the two main terminals (the source and the drain) of the transistor included in the switch element 203.

The conductive layer 306 forms wiring patterns connected to the two main terminals (the source and the drain) of the transistor included in the switch element 203. A part of the conductive layer 306 forms the signal line Sig, and another part of the conductive layer 306 forms a wiring pattern for connecting the conversion element 202 and the switch element 203.

The pixel 201 further includes an interlayer insulating film 307 that covers the insulating layer 303 and the conductive layer 306.

In the interlayer insulating film 307, a contact plug 308 for connecting to the conductive layer 306 (the switch element 203) is provided. The pixel 201 further includes a conductive layer 309, an insulating layer 310, a semiconductor layer 311, an impurity semiconductor layer 312, a conductive layer 313, a protection layer 314, an adhesive layer 315, and a scintillator 316 in this order on the interlayer insulating film 307. These layers form the conversion element 202 of the indirect type. The conductive layers 309 and 313 form a lower electrode and an upper electrode, respectively, of a photoelectric conversion element included in the conversion element 202. For example, the conductive layer 313 is composed of a transparent material. The conductive layer 309, the insulating layer 310, the semiconductor layer 311, the impurity semiconductor layer 312, and the conductive layer 313 form an MIS sensor as the photoelectric conversion element. For example, the impurity semiconductor layer 312 is formed of an n-type impurity semiconductor layer. For example, the scintillator 316 is composed of a gadolinium material or a cesium iodide (CsI) material and converts radiation into light.

Instead of the above example, the conversion element 202 may be configured as the conversion element 202 of the direct type that directly converts incident radiation into a charge. Examples of the conversion element 202 of the direct type include conversion elements having amorphous selenium, gallium arsenic, gallium phosphide, lead iodide, mercury iodide, cadmium telluride (CdTe), and cadmium zinc telluride (CdZnTe) as main materials. The conversion element 202 is not limited to the MIS type, and for example, may be a PN-type or PIN-type photodiode.

In the example illustrated in FIG. 3, in orthographic projection (a planar view) onto the surface of the insulating substrate 301 on which the pixel array 200 is formed, each of the plurality of signal lines Sig overlaps a part of the conversion element 202. This configuration has an advantage that the area of the conversion element 202 of each pixel 201 can be large.

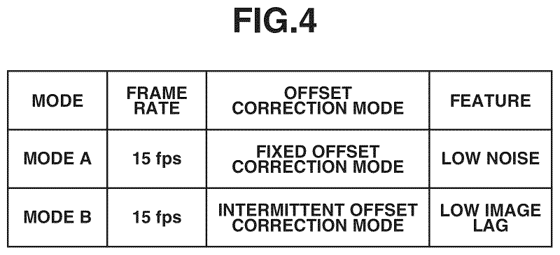

With reference to FIG. 4, the operation mode of the radiation imaging system 100 is described. In the present exemplary embodiment, the radiation imaging system 100 has two imaging modes. A mode A is a mode where imaging with low noise can be performed in a first offset imaging mode where the frame rate is 15 fps (hereinafter occasionally referred to also as a “fixed offset correction mode”). A mode B is a mode where imaging can be performed with a low afterimage in a second offset imaging mode where the frame rate is 15 fps (hereinafter occasionally referred to also as an “intermittent offset correction mode”). A technologist who performs imaging can select a mode suitable for the purpose of the imaging between the two modes.

Although in the present exemplary embodiment, the technologist selects a mode from the modes set in advance, the fixed offset correction mode and the intermittent offset correction mode may be able to be changed by rewriting a program for an FPGA.

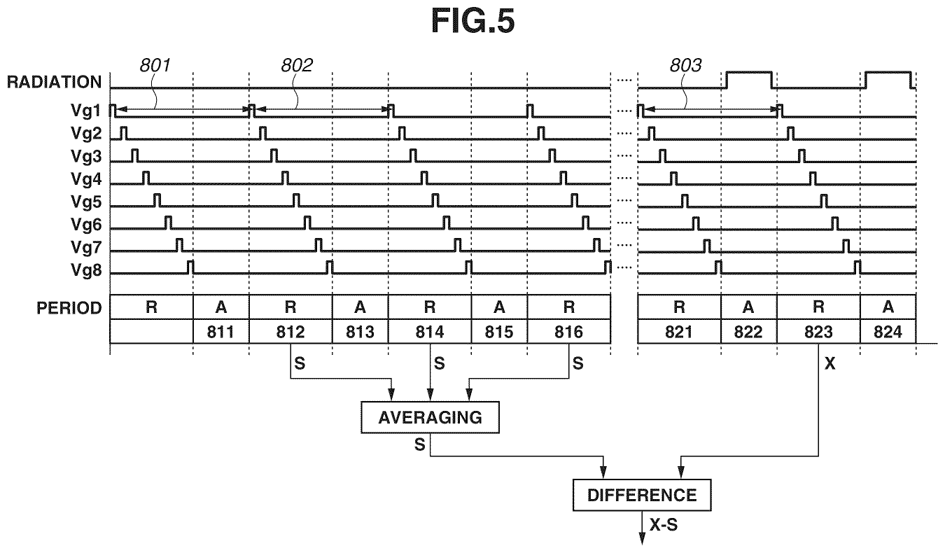

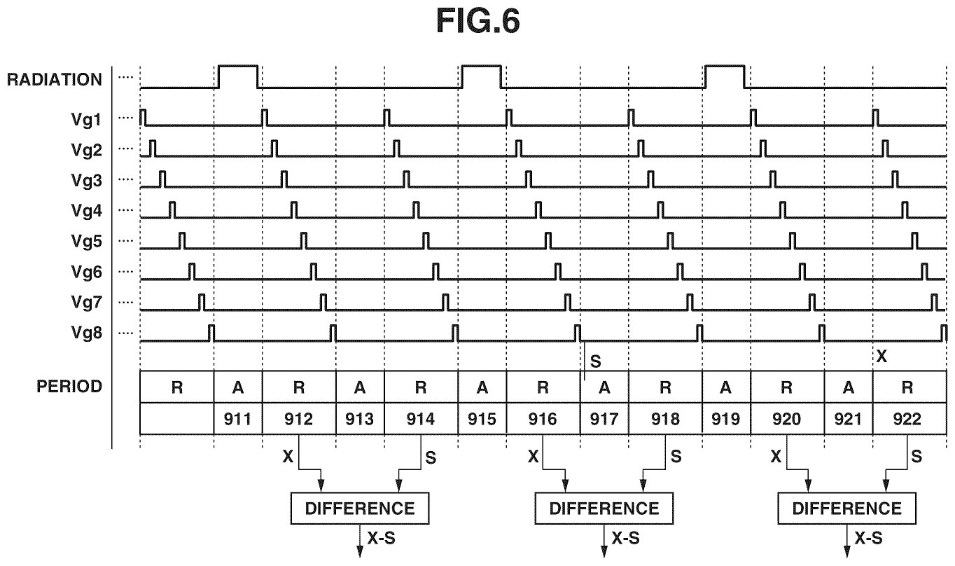

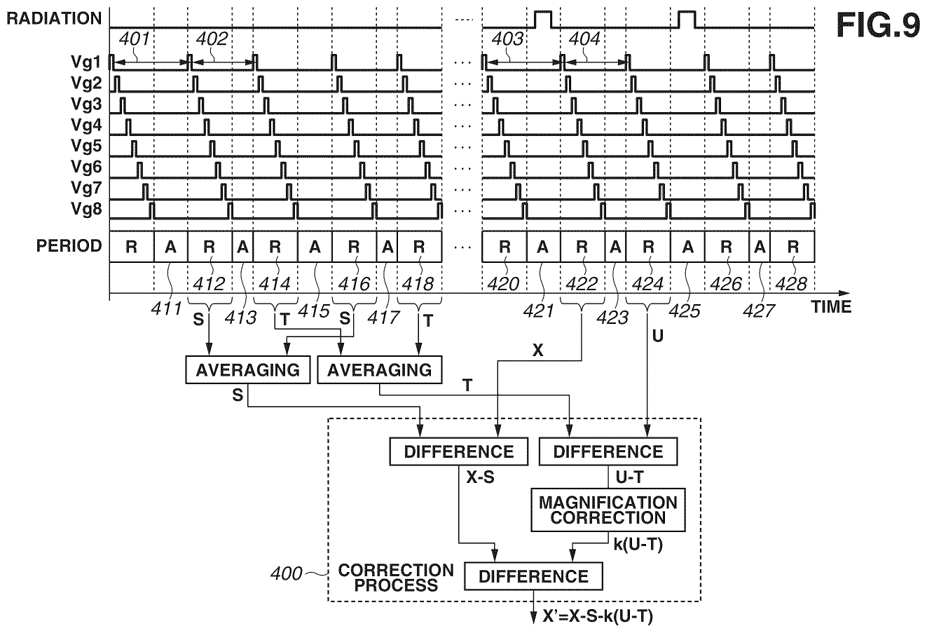

Next, with reference to FIG. 5, a description is given of an example of the operation of the radiation imaging system 100 in the fixed offset correction mode. The upper side of FIG. 5 illustrates a timing chart, and the lower side of FIG. 5 illustrates the flow of signal processing. The same applies to FIGS. 6 and 9. The operation illustrated in FIG. 5 is started by, for example, the user of the radiation imaging system 100 giving an instruction. The operation of the radiation imaging system 100 is controlled by the computer 120. The operation of the radiation imaging apparatus 110 is executed by the control circuit 112 under control of the computer 120. Specifically, the operation in FIG. 5 is executed by the control circuit 112 controlling the driving circuit 210 and the reading circuit 220. In the following description, that the control circuit 112 executes a particular operation by controlling the driving circuit 210 or the reading circuit 220 is represented simply as “the control circuit 112 executes a particular operation”.

In the timing chart in FIG. 5, “radiation” indicates whether the radiation 160 is emitted to the radiation imaging apparatus 110. A low level indicates that the radiation 160 is not emitted. A high level indicates that the radiation 160 is emitted.

In the timing chart in FIG. 5, “Vg1” to “Vg8” indicate the levels of driving signals supplied from the driving circuit 210 to the driving lines Vg1 to Vg8, respectively. Although in the example of FIG. 5, a case is described where the pixel array 200 includes eight pixel rows, the number of pixel rows is not limited to this.

In the timing chart in FIG. 5, “period” indicates a period when a particular operation is executed. Imaging by the radiation imaging apparatus 110 includes an accumulation period when an accumulation operation is executed (“A” in FIG. 5) and a reading period when a reading operation is executed (“R” in FIG. 5). The accumulation period indicated by “A” is occasionally referred to as an “accumulation time”. During the accumulation period, the control circuit 112 does not select any of the plurality of pixels 201 included in the pixel array 200. Specifically, the driving circuit 210 maintains the state where an off signal is supplied to each of the driving lines Vg1 to Vg8. Consequently, a charge generated in each conversion element 202 is accumulated in the conversion element 202, and simultaneously, a charge according to a dark current flowing through each conversion element 202 is also accumulated.

During the reading period, the control circuit 112 selects each of the plurality of pixels 201 included in the pixel array 200 and reads a signal from the selected pixel 201. Specifically, the driving circuit 210 supplies on signals one by one in order to the driving lines Vg1 to Vg8. In one embodiment, first, the driving circuit 210 supplies an on signal to only the driving line Vg1. Consequently, a switch element 203(1,j) (j=1, . . . , n) is turned on, and a conversion element 202(1,j) and the signal line Sigj enter a conducting state. Thus, a charge accumulated in the conversion element 202(1,j) is read to the signal line Sigj. Next, the driving circuit 210 supplies an on signal to only the driving line Vg2. Consequently, a switch element 203(2,j) is turned on, and a conversion element 202(2,j) and the signal line Sigj enter a conducting state. Thus, a charge accumulated in the conversion element 202(2,j) is read to the signal line Sigj. The driving circuit 210 repeats such an operation up to the driving line Vg8, whereby a signal based on a charge accumulated in each conversion element 202 is read by the reading circuit 220 via the signal line Sigj. In the following description, that the reading operation is executed on the plurality of pixels 201 means that the reading operation is executed on each of the plurality of pixels 201.

The operations by the radiation imaging apparatus 110 include an operation executed during the preparation for imaging before the transmission of a permission signal for the emission of the radiation 160, and an operation executed after the preparation for the imaging is completed after the transmission of the permission signal. A period after the preparation for the imaging is completed may include a period when a radiation image is captured, and may further include a period when a moving image is captured. The period when a radiation image is captured may also be referred to as an “imaging period”. As will be described below, during the imaging period, the radiation 160 does not need to always be emitted to the radiation imaging apparatus 110, and the radiation 160 may be intermittently emitted.

During the preparation for the imaging, the radiation 160 is not emitted to the radiation imaging apparatus 110. The preparation for the imaging may be completed according to the satisfaction of a predetermined condition. For example, the predetermined condition may be that a predetermined number of offset image signals are generated. According to the completion of the preparation for the imaging, the radiation imaging apparatus 110 notifies the computer 120 of a permission signal indicating that the radiation 160 can be emitted.

After the preparation for the imaging is completed, the radiation 160 is emitted to the radiation imaging apparatus 110, and a radiation image according to the radiation 160 is generated. As illustrated in FIG. 5, the radiation 160 may be emitted as a plurality of pulses to the radiation imaging apparatus 110. The radiation imaging apparatus 110 may generate a radiation image with respect to each pulse. In a case where the radiation imaging apparatus 110 executes moving image capturing, a radiation image with respect to each pulse may form a frame of the moving image.

During the preparation for the imaging, the control circuit 112 alternately executes the accumulation operation and the reading operation. As illustrated in FIG. 5, during an accumulation period 811, the control circuit 112 executes the accumulation operation, and during a reading period 812 after the accumulation period 811, the control circuit 112 reads signals based on charges accumulated in the plurality of pixels 201. Also, from an accumulation period 813 to a reading period 816, similarly, the control circuit 112 reads at least signals based on charges accumulated during an accumulation period during a reading period after the accumulation period. Signals (offset correction signals) read from the pixels 201 during the preparation for the imaging are used to generate an offset image signal. Thus, the offset correction signals are signals obtained by reading charges accumulated in the conversion elements 202 not based on the emission of the radiation 160.

During the reading period 812, signals based on charges accumulated over a time length 801 are read from the pixels 201. The time length 801 is the length of the time from when the previous reading operation on the pixels 201 is completed (i.e., when the driving signals change to the low levels) to when the current reading operation on the pixels 201 is completed (i.e., when the driving signals change to the low levels again). The same applies to other time lengths over which charges are accumulated. The time length 801 includes the accumulation period (accumulation time) 811. During the reading period 814, signals based on charges accumulated over a time length 802 are read from the pixels 201. The time length 802 includes the accumulation period (accumulation time) 813.

Based on the offset signal read from each of the plurality of pixels 201 included in the pixel array 200, the image generation circuit 113 as the image generation unit generates an offset image signal S. The offset image signal S is represented as a matrix having m rows and n columns, and a correction signal (an offset signal) read from the pixel 201(i,j) is an (i,j) component of the matrix.

The control circuit 112 repeatedly executes the operations from the accumulation period 811 to the reading period 812. More specifically, also from the accumulation period 813 to the reading period 816, the same operations as those from the accumulation period 811 to the reading period 812 are executed. As described above, during the preparation for the imaging, the control circuit 112 executes the operation of reading offset signals multiple times.

After the preparation for the imaging is completed, the control circuit 112 generates a permission signal permitting the emission of the radiation 160, transmits the permission signal to the computer 120 via the communication unit 115, and also starts capturing a moving image (i.e., capturing a plurality of radiation images). Specifically, the control circuit 112 alternately executes the accumulation operation and the reading operation. As illustrated in FIG. 5, during an accumulation period (accumulation time) 822, the control circuit 112 executes the accumulation operation, and during a reading period 823 after the accumulation period 822, the control circuit 112 reads radiation signals based on charges accumulated in the plurality of pixels 201. Signals read from the pixels 201 after the preparation for the imaging is completed are used to generate a radiation image.

During the reading period 823, signals based on charges accumulated over a time length 803 are read from the pixels 201. The time length 803 includes the accumulation period (accumulation time) 822. The accumulation period 822 includes a period when the radiation 160 is emitted to the radiation imaging apparatus 110. Thus, the time length 803 includes a period when the radiation 160 is emitted to the radiation imaging apparatus 110. The time length 803 may be equal to the time length 801.

In the example illustrated in FIG. 5, the signals read from the pixels 201 during the reading period 823 are referred to as “radiation signals”. The radiation signals include components according to the radiation 160 emitted to the radiation imaging apparatus 110 during the accumulation period 822.

Based on the radiation signal read from each of the plurality of pixels 201 included in the pixel array 200, the image generation circuit 113 generates a radiation image signal X. The radiation image signal X is represented as a matrix having m rows and n columns, and a signal read from the pixel 201(i,j) is an (i,j) component of the matrix.

The control circuit 112 repeatedly executes the operations from the accumulation period 822 to the reading period 823. As described above, after the preparation for the imaging is completed (e.g., during the capturing of a moving image), the control circuit 112 executes the reading operation of reading radiation signals.

Next, a description is given of a method in which the image generation circuit 113 corrects the radiation image signal X using the offset image signal S. As described above, the components of the offset image signal S are given by the offset signals (the correction signals), and the components of the radiation image signal X are given by the radiation signals.

Thus, the radiation signals are subjected to a correction process using the offset signals (the correction signals), thereby generating radiation image data.

As described above, during the preparation for the imaging, the control circuit 112 executes the generation of an offset image signal S. Consequently, a plurality of offset image signals S is generated. During the preparation for the imaging, the image generation circuit 113 averages the plurality of offset image signals S, thereby creating a single offset image signal S. Then, the image generation circuit 113 stores the single offset image signal S in the memory of the image generation circuit 113 for a subsequent process. A plurality of offset image signals is thus averaged, whereby it is possible to reduce noise included in the offset image signals. The number of offset image signals used for the averaging may be three as illustrated in FIG. 5, or may be four or more. The number of offset image signals used for the averaging may be set in advance.

After the preparation for the imaging is completed, the image generation circuit 113 generates a radiation image signal X and stores the radiation image signal X in the memory of the image generation circuit 113. The image generation circuit 113 reads the offset image signal S from the memory and subtracts the offset image signal S from the radiation image signal X, thereby generating radiation afterimage image data (“X-S” in FIG. 5).

The image generation circuit 113 transmits the radiation image data X-S after correction to the computer 120.

As described above, in imaging in the fixed offset correction mode, a plurality of offset image signals S is averaged, and therefore, it is possible to perform imaging with low noise.

Next, with reference to FIG. 6, a description is given of an example of the operation of the radiation imaging apparatus 110 in the intermittent offset correction mode different from the above operation in FIG. 5. In the operation of FIG. 5, during the preparation for imaging, a plurality of offset image signals S is acquired and averaged. In the intermittent offset correction mode illustrated in FIG. 6, however, during the preparation for imaging, an offset image signal S is not acquired.

The control circuit 112 alternately executes the accumulation operation and the reading operation. Specifically, after the transmission of a permission signal permitting the emission of the radiation 160, then as illustrated in FIG. 6, during an accumulation period (accumulation time) 911, the control circuit 112 executes the accumulation operation. During a reading period 912 after the accumulation period 911, the control circuit 112 reads signals based on charges accumulated in the plurality of pixels 201. During the accumulation period 911, the radiation 160 is emitted to the radiation imaging apparatus 110, and during the reading period 912 after the accumulation period 911, the control circuit 112 reads signals (radiation signals) based on charges generated by the radiation 160 and accumulated in the plurality of pixels 201. Based on the radiation signal read from each of the plurality of pixels 201 included in the pixel array 200, the image generation circuit 113 generates a radiation image signal X.

Then, during the accumulation period 913, the radiation 160 is not emitted to the radiation imaging apparatus 110, and the control circuit 112 reads signals based on charges generated by a dark current and an afterimage and accumulated in the plurality of pixels 201. In other words, the control circuit 112 reads charges accumulated in the conversion elements 202 not based on the emission of the radiation 160 after the transmission of the permission signal. Based on the offset signal read from each of the plurality of pixels 201 included in the pixel array 200, the image generation circuit 113 generates an offset image signal S.

Next, a description is given of a method in which the image generation circuit 113 corrects the radiation image signal X using the offset image signal S. As described above, the components of the offset image signal S are given by the offset signals, and the components of the radiation image signal X are given by the radiation signals.

The image generation circuit 113 generates a radiation image signal X and stores the radiation image signal X in the memory of the image generation circuit 113. The image generation circuit 113 also generates an offset image signal S and stores the offset image signal S in the memory of the image generation circuit 113. The image generation circuit 113 reads the radiation image signal X and the offset image signal S from the memory and subtracts the offset image signal S from the radiation image signal X, thereby generating radiation afterimage image data (“X-S” in FIG. 6).

The image generation circuit 113 transmits the radiation image data X-S after correction to the computer 120.

As described above, in imaging in the intermittent offset correction mode, offset correction is performed using an offset image signal S immediately after a radiation image signal X is acquired. Thus, if an afterimage is included in a radiation image signal X, offset correction is performed using an offset image signal S temporally close to the radiation image signal X, and therefore, it is possible to correct an afterimage component.

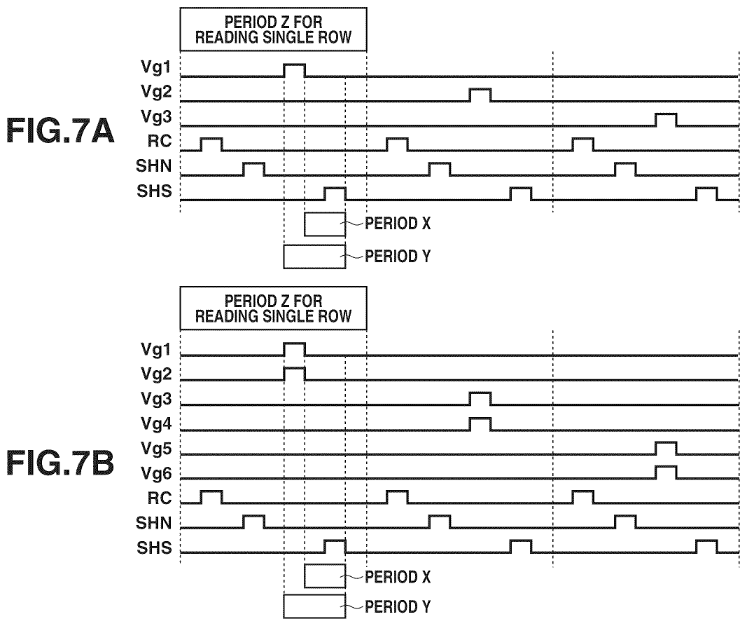

Next, with reference to FIGS. 7A and 7B and FIG. 2, a description is given of detailed driving for reading a single row.

FIGS. 7A and 7B are different from each other in the following respects. In FIG. 7A, the driving lines Vg1 to Vg3 are sequentially read with respect to each row, whereas in FIG. 7B, two rows, namely the driving lines Vg1 and Vg2, the driving lines Vg3 and Vg4, or the driving lines Vg5 and Vg6, are simultaneously read. Although FIGS. 7A and 7B illustrate the time for reading a single row, the following description is given on the assumption that as illustrated in FIG. 7B, driving for simultaneously reading two rows, namely the driving lines Vg1 and Vg2, also corresponds to the time for reading a single row.

First, if the reset switch is turned on according to a control signal RC (a reset pulse) supplied from the control circuit 112 to the amplification circuit 221, the integrating capacitor is reset, and the potential of the signal line Sig is also reset to a reference potential.

After the integrating capacitor is reset, a control signal SHN is output to sample kTC noise that appears in the output of the integrating amplification circuit 222. The switch element 224N is turned on and off, and kTC noise is sampled by the capacitor 225N.

Next, an on signal is supplied from the driving circuit 210 to the driving line Vg1 in the first row. If the switch element 203 is turned on, the conversion element 202 and the signal line Sig enter a conducting state, and a charge obtained by the conversion element 202 is transferred to the signal line Sig and input to the amplification circuit 221. The integrating amplification circuit 222 converts the input charge into a voltage signal and outputs the voltage signal.

Next, a control signal SHS is output, the switch element 224S is turned on and off, and the signal from the conversion element 202 output from the integrating amplification circuit 222 is sampled by the capacitor 225S.

Then, the multiplexer 227 sequentially sends the voltage signals held in the capacitors 225N and 225S to the AD converter 240, and the AD converter 240 converts the voltage signals into digital signals.

A time Z for reading a single row that is illustrated in FIGS. 7A and 7B includes the above times. In the present exemplary embodiment, the time Z for reading a single row is changed depending on the offset correction mode. Specifically, in the fixed offset correction mode (the first offset imaging mode) as the mode A, reading is performed in a time of 40 μs, for example. In the intermittent offset correction mode (the second offset imaging mode) as the mode B, reading is performed in 30 μs, for example.

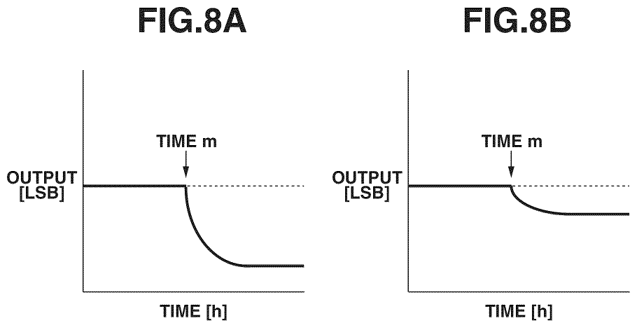

FIGS. 8A and 8B illustrate influences on the time Z for reading a single row and temperature changes.

FIG. 8A illustrates changes in a digital value output from the AD converter 240 in a case where the time Z for reading a single row is 30 μs. FIG. 8B illustrates changes in the digital value output from the AD converter 240 in a case where the time Z for reading a single row is 40 μs.

FIGS. 8A and 8B both illustrate changes in the digital value output from the AD converter 240 in a case where the outside air temperature of the radiation imaging apparatus 110 is changed by 10° C. at a time m.

As illustrated in FIGS. 8A and 8B, it is understood that in a case where the outside air temperature of the radiation imaging apparatus 110 changes, and if the time Z for reading a single row is longer, changes in the digital value output from the AD converter 240 are smaller. The pixel array 200, the driving circuit 210, and the reading circuit 220 are composed of semiconductor elements and passive elements, and the characteristics of the pixel array 200, the driving circuit 210, and the reading circuit 220 change relative to temperature. Thus, the temporal responses of the semiconductor elements and the passive elements also change. Thus, if the time Z for reading a single row is longer, stability against temperature changes also improves.

Particularly, the influence of the time from when an on signal or an off signal is supplied from the driving circuit 210 to the driving line Vg to when a voltage is held in the signal sample and hold circuit according to a control signal SHS is great (this corresponds to a period X and a period Y in FIGS. 7A and 7B). In this case, the voltage of the on signal supplied to the driving line Vg is high, namely 10 V or more, and the voltage of the off signal supplied to the driving line Vg is low, namely −5 V or less. Thus, the influence of amplitude is particularly great.

In the present exemplary embodiment, the time Z for reading a single row is shorter in the intermittent offset correction mode as the second offset imaging mode than in the fixed offset correction mode as the first offset imaging mode. In the fixed offset correction mode, an offset image signal S is acquired during the preparation for imaging, and there is spare time before the acquisition of a radiation image signal X. Thus, if the temperature changes during this period, an artifact occurs in an X-S image after offset correction. On the other hand, in the intermittent offset correction mode, an offset image signal S is acquired immediately after the acquisition of a radiation image signal X. Thus, the offset image signal S can be acquired in the state where the temperature hardly changes. Thus, an artifact is less likely to occur in an X-S image after offset correction.

In the intermittent offset correction mode, two images, namely a radiation image signal X and an offset image signal S, are acquired, and an image signal for one frame is created. Thus, the frame rate decreases. As illustrated in the present exemplary embodiment, the time Z for reading a single row is made short in the intermittent offset correction mode, whereby it is possible to improve the frame rate.

As described above, in the fixed offset correction mode, the time Z for reading a single row is made long, whereby it is possible to improve stability against temperature changes. In the intermittent offset correction mode, the time Z for reading a single row is made short, whereby it is possible to improve the frame rate.

Next, with reference to FIG. 9, a description is given of the case of a third offset imaging mode (hereinafter referred to as an “intermittent hybrid offset correction mode”) obtained by combining the fixed offset correction mode and the intermittent offset correction mode.

Before the transmission of a permission signal permitting the emission of the radiation 160 (during the preparation for imaging), the control circuit 112 alternately executes the accumulation operation and the reading operation. As illustrated in FIG. 9, during an accumulation period (accumulation time) 411, the control circuit 112 executes the accumulation operation, and during a reading period 412 after the accumulation period 411, the control circuit 112 reads signals based on charges accumulated in the plurality of pixels 201. Also, from an accumulation period (accumulation time) 413 to a reading period 418, similarly, the control circuit 112 reads at least signals based on charges accumulated during an accumulation period during a reading period after the accumulation period. Signals read from the pixels 201 during the preparation for the imaging are used to generate an offset image signal.

During the reading period 412, signals based on charges accumulated over a time length 401 are read from the pixels 201. The time length 401 is the length of the time from when the previous reading operation on the pixels 201 is completed (i.e., when the driving signals change to the low levels) to when the current reading operation on the pixels 201 is completed (i.e., when the driving signals change to the low levels again). The same applies to other time lengths over which charges are accumulated. The time length 401 includes the accumulation period (accumulation time) 411. During the reading period 414, signals based on charges accumulated over a time length 402 are read from the pixels 201. The time length 402 includes the accumulation period (accumulation time) 413.

In the example illustrated in FIG. 9, the accumulation period (accumulation time) 413 is shorter than the accumulation period (accumulation time) 411. Due to this, the time length 402 is shorter than the time length 401. Accordingly, the signals read from the pixels 201 during the reading period 412 are referred to as “long-time offset signals”, and the signals read from the pixels 201 during the reading period 414 are referred to as “short-time offset signals”.

Based on the long-time offset signal read from each of the plurality of pixels 201 included in the pixel array 200, the image generation circuit 113 generates a long-period offset image signal S. The long-period offset image signal S is represented as a matrix having m rows and n columns, and a signal read from the pixel 201(i,j) is an (i,j) component of the matrix. Based on the short-time offset signal read from each of the plurality of pixels 201 included in the pixel array 200, the image generation circuit 113 generates a short-period offset image signal T. The short-period offset image signal T is represented as a matrix having m rows and n columns, and a signal read from the pixel 201 (i,j) is an (i,j) component of the matrix.

The control circuit 112 repeatedly executes the operations from the accumulation period 411 to the reading period 414. More specifically, also from the accumulation period 415 to the reading period 418, the same operations as those from the accumulation period 411 to the reading period 414 are executed. As described above, during the preparation for the imaging, the control circuit 112 alternately executes the reading operation of reading long-time offset signals and the reading operation of reading short-time offset signals.

After the preparation for the imaging is completed, the control circuit 112 generates a permission signal permitting the emission of the radiation 160, transmits the permission signal to the computer 120 via the communication unit 115, and also starts capturing a moving image (i.e., capturing a plurality of radiation images). Specifically, the control circuit 112 alternately executes the accumulation operation and the reading operation. As illustrated in FIG. 9, during an accumulation period (accumulation time) 421, the control circuit 112 executes the accumulation operation, and during a reading period 422 after the accumulation period 421, the control circuit 112 reads signals based on charges accumulated in the plurality of pixels 201. Also, from an accumulation period 423 to a reading period 428, similarly, the control circuit 112 reads at least signals based on charges accumulated during an accumulation period during a reading period after the accumulation period. Signals read from the pixels 201 after the preparation for the imaging is completed are used to generate a radiation image signal and an offset image signal.

During the reading period 422, signals based on charges accumulated over a time length 403 are read from the pixels 201. The time length 403 includes the accumulation period (accumulation time) 421. The accumulation period 421 includes a period when the radiation 160 is emitted to the radiation imaging apparatus 110. Thus, the time length 403 includes a period when the radiation 160 is emitted to the radiation imaging apparatus 110. The time length 403 may be equal to the time length 401. During the reading period 424, signals based on charges accumulated over a time length 404 are read from the pixels 201. The time length 404 includes the accumulation period (accumulation time) 423. The time length 404 does not include a period when the radiation 160 is emitted to the radiation imaging apparatus 110. The time length 404 may be equal to the time length 402.

In the example illustrated in FIG. 9, the accumulation period (accumulation time) 423 is shorter than the accumulation period (accumulation time) 421. Due to this, the time length 404 is shorter than the time length 403. The signals read from the pixels 201 during the reading period 422 are referred to as “radiation signals”, and the signals read from the pixels 201 during the reading period 424 are referred to as “time-of-imaging offset signals”. The radiation signals include components according to the radiation 160 emitted to the radiation imaging apparatus 110 during the accumulation period 421. The accumulation period (accumulation time) 423 is made shorter than the accumulation period (accumulation time) 421, whereby it is possible to improve the frame rate of a moving image generated by the radiation imaging apparatus 110.

Based on the radiation signal read from each of the plurality of pixels 201 included in the pixel array 200, the image generation circuit 113 generates a radiation image signal X. The radiation image signal X is represented as a matrix having m rows and n columns, and a signal read from the pixel 201(i,j) is an (i,j) component of the matrix. Based on the time-of-imaging offset signal read from each of the plurality of pixels 201 included in the pixel array 200, the image generation circuit 113 generates a time-of-imaging offset image signal U. The time-of-imaging offset image signal U is represented as a matrix having m rows and n columns, and a signal read from the pixel 201(i,j) is an (i,j) component of the matrix.

The control circuit 112 repeatedly executes the operations from the accumulation period 421 to the reading period 424. More specifically, also from the accumulation period 425 to the reading period 428, the same operations as those from the accumulation period 421 to the reading period 424 are executed. As described above, after the preparation for the imaging is completed (e.g., during the capturing of a moving image), the control circuit 112 alternately executes the reading operation of reading radiation signals and the reading operation of reading time-of-imaging offset signals.

Next, a description is given of a method in which the image generation circuit 113 corrects the radiation image signal X using the long-period offset image signal S, the short-period offset image signal T, and the time-of-imaging offset image signal U. As described above, the components of the long-period offset image signal S are given by the long-time offset signals, the components of the short-period offset image signal T are given by the short-time offset signals, the components of the time-of-imaging offset image signal U are given by the time-of-imaging offset signals, and the components of the radiation image signal X are given by the radiation signals. In the following method, the radiation signals are corrected using the long-time offset signals, the short-time offset signals, and the time-of-imaging offset signals.

As described above, during the preparation for the imaging, i.e., before the transmission of a permission signal for the emission of the radiation 160, the control circuit 112 alternately executes the generation of a long-period offset image signal S and the generation of a short-period offset image signal T. Consequently, a plurality of long-period offset image signals S and a plurality of short-period offset image signals T are generated. During the preparation for the imaging, the image generation circuit 113 averages the plurality of long-period offset image signals S, thereby creating a single long-period offset image signal S. Then, the image generation circuit 113 stores the single long-period offset image signal S in the memory of the image generation circuit 113 for a subsequent process. Similarly, during the preparation for the imaging, the image generation circuit 113 averages the plurality of short-period offset image signals T, thereby creating a single short-period offset image signal T. Then, the image generation circuit 113 stores the single short-period offset image signal T in the memory of the image generation circuit 113 for the subsequent process. A plurality of offset image signals is thus averaged, whereby it is possible to reduce noise included in the offset image signals. The number of offset image signals used for the averaging may be two as illustrated in FIG. 9, or may be three or more. The number of offset image signals used for the averaging may be set in advance.

The image generation circuit 113 generates a radiation image signal X and a time-of-imaging offset image signal U and stores the radiation image signal X and the time-of-imaging offset image signal U in the memory of the image generation circuit 113. The image generation circuit 113 reads the long-period offset image signal S from the memory and subtracts the long-period offset image signal S from the radiation image signal X, thereby generating a radiation afterimage image signal (“X-S” in FIG. 9). The image generation circuit 113 also reads the short-period offset image signal T from the memory and subtracts the short-period offset image signal T from the time-of-imaging offset image signal U, thereby generating an offset afterimage image signal (“U-T” in FIG. 9).

An afterimage component included in each of the radiation afterimage image signal and the offset afterimage image signal is proportional to the time length over which the charges are accumulated in the pixels 201. Accordingly, the image generation circuit 113 multiplies a coefficient k equal to the ratio of the time length 403 to the time length 404 (i.e., a value obtained by dividing the time length 403 by the time length 404) by each component of the offset afterimage image signal. This generates an adjusted afterimage image signal (“k(U−T)” in FIG. 9). Then, the image generation circuit 113 subtracts the adjusted afterimage image signal from the radiation afterimage image signal, thereby generating radiation image data X′ (=X−kU+(kT−S)). The radiation image data X′ is image data obtained by correcting the radiation image signal X using the long-period offset image signal S, the short-period offset image signal T, the time-of-imaging offset image signal U, and the coefficient k. The image generation circuit 113 transmits the radiation image data X′ after correction to the computer 120.

The above order of calculations for generating the radiation image data X′ is merely an example, and the radiation image data X′ may be calculated in another order. The radiation image data X′, i.e., X−S−k(U−T), is transformed to X−kU+(kT−S). Accordingly, during the preparation for the imaging, the image generation circuit 113 may calculate kT−S using the long-period offset image signal S, the short-period offset image signal T, and the coefficient k and store this value as a correction value in the memory of the image generation circuit 113. The coefficient k can be determined based on advance settings before the timing when the driving circuit 210 supplies an on signal to the pixel array 200. During the capturing of a moving image, the image generation circuit 113 may correct the radiation image signal X using the time-of-imaging offset image signal U, the correction value stored in the memory, and the coefficient k. As described above, the correction value is stored instead of storing the long-period offset image signal S and the short-period offset image signal T, whereby it is possible to reduce the consumption amount of the memory of the image generation circuit 113.

Next, a description is given of the technical significance of the alternate execution of the acquisition of a long-period offset image signal S and the acquisition of a short-period offset image signal T. The driving lines Vg1 to Vgm have a variety of types of capacitive coupling in the pixel array 200. For example, the driving line Vg2 intersects the signal lines Sig1 to Sign at a plurality of points in the pixel array 200 and has capacitive coupling at these intersection points. The driving line Vg2 extends parallel to the driving line Vg3 and therefore also has capacitive coupling with the driving line Vg3. The driving line Vg2 extends parallel to a part of the bias line Bs and therefore also has capacitive coupling with the bias line Bs. Further, the driving line Vg2 has capacitive coupling with a node at a connection portion of a switch element 203 and a conversion element 202.

According to a change in the level of a driving signal supplied to the driving line Vg due to such capacitive coupling, the potentials of the signal line Sig, the bias line Bs, another driving line Vg, and the node at the connection portion of the switch element 203 and the conversion element 202 also change. The signal line Sig, the bias line Bs, the driving line Vg, and the node at the connection portion of the switch element 203 and the conversion element 202 of which the potentials have changed return to the original potentials with the lapse of time. However, the amount of return differs depending on the length of the accumulation period.

Even if a switch element 203 is in an off state, a leakage current can flow through the switch element 203. When the switch element 203 is turned off, the node between the conversion element 202 and the switch element 203 changes to the low level due to charge injection from the control terminal (the gate). Thus, immediately after the switch element 203 is turned off, a potential difference occurs between the main terminals (the source and the drain), and a leakage current flows through the switch element 203. The leakage current depends on the potential difference between the two main terminals (the source and the drain) of the switch element 203. If a leakage current flows during an accumulation period, this potential difference becomes small. Thus, the leakage current differs according to the length of the accumulation period. If a leakage current flows through the switch element 203, a current also flows through the signal line Sig and the bias line Bs.

For the above reasons, an offset image signal to be acquired can differ between a case where each of a long-period offset image signal S and a short-period offset image signal T is acquired multiple times in a row and a case where a long-period offset image signal S and a short-period offset image signal T are alternately acquired. In the above operation of the radiation imaging apparatus 110, during the preparation for imaging, a long-period offset image signal S and a short-period offset image signal T are alternately acquired, and after the preparation for the imaging is completed, a radiation image signal X and a time-of-imaging offset image signal U are alternately acquired. Consequently, it is possible to bring the state of capacitive coupling in the pixel array 200 during the preparation for the imaging and the state of capacitive coupling in the pixel array 200 during the capturing of a radiation image close to each other. Thus, it is possible to reduce noise included in the radiation image signal X with high accuracy.

In the operation in FIG. 9, using a time-of-imaging offset signal acquired after a radiation signal, the image generation circuit 113 corrects the radiation signal. Alternatively, using a time-of-imaging offset signal acquired before a radiation signal, the image generation circuit 113 may correct the radiation signal. For example, the image generation circuit 113 may correct a radiation image signal X in the second frame in moving image capturing using a time-of-imaging offset image signal U in the first frame.

In the above example, the time length 401 is equal to the time length 403. Alternatively, these time lengths may be different from each other. In a case where the time lengths are thus different from each other, the image generation circuit 113 may multiply the ratio of the time length 403 to the time length 401 by each component of a long-period offset image signal S and then subtract the result from a radiation image signal X. In the above example, the time length 402 is equal to the time length 404. Alternatively, these time lengths may be different from each other. In a case where the time lengths are thus different from each other, the image generation circuit 113 may multiply the ratio of the time length 404 to the time length 402 by each component of a short-period offset image signal T and then subtract the result from a time-of-imaging offset image signal U.

In a case where the offset correction illustrated in FIG. 9 is performed, there is a long spare time before the calculation of the difference between a radiation image signal X and a long-period offset image signal S or the calculation of the difference between a time-of-imaging offset image signal U and a short-period offset image signal T. Thus, although this is similar to the fixed offset correction mode, X−S−k(U−T) is obtained in the intermittent offset correction mode after that. Thus, even if a change occurs due to temperature, the influence of the change is small. Thus, it is possible to make the time Z for reading a single row shorter than that in the fixed offset correction. Then, all of the times for reading a long-period offset image signal S, a short-period offset image signal T, a radiation image signal X, and a time-of-imaging offset image signal U are made short. In this example, as an example, as described above, the time Z for reading a single row is a short reading time, namely 30 μsec. As a result, it is possible to improve stability against temperature changes while improving the frame rate.

The time Z for reading a single row is merely an example, and is not limited to this. The combination of the time Z for reading a single row in the fixed offset correction mode and the time Z for reading a single row in the intermittent offset correction mode is optimized, whereby it is also possible to make the frame rates in both modes the same. Similarly, the combinations of the time Z for reading a single row in the fixed offset correction mode and the time Z for reading a single row and accumulation times (the accumulation times 413 and 423) in the intermittent hybrid offset correction mode are optimized, whereby it is also possible to make the frame rates in both modes the same.

As illustrated in FIGS. 5, 6, and 9, in so-called moving image capturing in which a plurality of images is continuously acquired, a case where a permission signal for the emission of the radiation 160 is transmitted with respect to each radiation pulse (a case where a permission signal is transmitted multiple times during the moving image capturing) is possible. In this case, the times before and after the transmission of a permission signal are determined using as a reference the transmission timing of the first permission signal in the moving image (continuous) capturing. For example, the imaging sequence in FIG. 9 is considered. In the case of a form in which a series of operations in moving image capturing is performed by transmitting a permission signal at the timing of the beginning of each of the accumulation periods 421 and 425, the times before and after the transmission of a permission signal are determined using as a reference the permission signal transmitted at the timing of the beginning of the accumulation period 421. More specifically, in this imaging form, the time before the period 421 (from the period 411 to the period 420) is before the transmission of a permission signal, and the time after the period 421 (from the period 421 to the period 428) is after the transmission of a permission signal. The same applies to the forms in FIGS. 5 and 6 (a permission signal in the capturing of the first moving image is used as a reference).

The disclosure is not limited to the above-described exemplary embodiments, and various modifications and variations can be made without departing from the spirit and scope of the disclosure. Accordingly, the appended claims are intended to disclose the scope of the disclosure.

According to the disclosure, it is possible to improve the frame rate in an intermittent offset correction mode and also improve stability against temperature changes in a fixed offset correction mode.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-070114, filed Apr. 23, 2024, which is hereby incorporated by reference herein in its entirety.

What is claimed is:

1. An apparatus comprising:
a conversion element configured to accumulate a charge for generating an image;
a communication unit configured to transmit, to an external apparatus, a permission signal permitting emission of radiation;
a reading unit configured to read the charge accumulated in the conversion element and generate a signal; and
a generation unit configured to generate image data from the generated signal,
wherein the reading unit generates a first correction signal by reading a charge accumulated in the conversion element during a first reading time before transmission of the permission signal, generates a radiation signal by reading a charge accumulated in the conversion element based on the emission of the radiation after the transmission of the permission signal, and generates a second correction signal by reading a charge accumulated in the conversion element not based on the emission of the radiation during a second reading time after the transmission of the permission signal,
wherein the generation unit generates image data by performing a correction process on the radiation signal using the first or second correction signal, and
wherein the second reading time is shorter than the first reading time.

2. The apparatus according to claim 1, further comprising:
a switch element, one terminal of which is connected to the conversion element and the other terminal of which is connected to the reading unit; and
a driving unit configured to supply, to the switch element, a driving signal for switching on and off states of the switch element,
wherein the reading unit includes:
an amplification circuit configured to convert the charge accumulated in the conversion element into a voltage signal; and
a hold circuit configured to hold the voltage signal,
wherein generation of the first correction signal and generation of the second correction signal are performed by the hold circuit holding the voltage signal, and
wherein a time from when the switch element switches from the off state to the on state by supplying the driving signal to when the hold circuit holds the voltage signal is shorter in the generation of the second correction signal than in the generation of the first correction signal.

3. The apparatus according to claim 1, further comprising:
a switch element, one terminal of which is connected to the conversion element and the other terminal of which is connected to the reading unit; and
a driving unit configured to supply, to the switch element, a driving signal for switching on and off states of the switch element,
wherein the reading unit includes:
an amplification circuit configured to convert the charge accumulated in the conversion element into a voltage signal; and
a hold circuit configured to hold the voltage signal,
wherein generation of the first correction signal and generation of the second correction signal are performed by the hold circuit holding the voltage signal, and
wherein a time from when the switch element switches from the on state to the off state by supplying the driving signal to when the hold circuit holds the voltage signal is shorter in the generation of the second correction signal than in the generation of the first correction signal.

4. The apparatus according to claim 1,
wherein, after the transmission of the permission signal, the reading unit generates a first radiation signal by reading a charge accumulated in the conversion element based on the emission of the radiation during the first reading time or generates a second radiation signal by reading a charge accumulated in the conversion element based on the emission of the radiation during the second reading time, and
wherein the generation unit operates in a first offset imaging mode for generating image data using the first radiation signal and the first correction signal, and a second offset imaging mode for generating image data using the second radiation signal and the second correction signal.

5. The apparatus according to claim 4, wherein the reading unit controls the first and second reading times so that a time from when the communication unit transmits the permission signal to when the generation unit generates the image data is same in the first and second offset imaging modes.

6. The apparatus according to claim 4,
wherein the reading unit generates a third correction signal by reading a charge accumulated in the conversion element during the second reading time before the transmission of the permission signal, and
wherein the generation unit operates in a third offset imaging mode for generating image data using the second radiation signal, the second correction signal, and the third correction signal.

7. The apparatus according to claim 6, wherein the reading unit reads the charge accumulated in the conversion element so that the accumulated charge is a charge accumulated during a first accumulation time or a second accumulation time shorter than the first accumulation time.

8. The apparatus according to claim 7, wherein the reading unit controls the first and second accumulation times and the first and second reading times so that a time from when the communication unit transmits the permission signal to when the generation unit generates the image data is same in the first and third offset imaging modes.

9. A system comprising:
the apparatus according to claim 1; and
a control unit configured to acquire the image data generated by the generation unit and perform image processing on the image data.

10. The system according to claim 9,
wherein the apparatus further comprises:
a switch element, one terminal of which is connected to the conversion element and the other terminal of which is connected to the reading unit; and
a driving unit configured to supply, to the switch element, a driving signal for switching on and off states of the switch element,
wherein the reading unit includes:
an amplification circuit configured to convert the charge accumulated in the conversion element into a voltage signal; and
a hold circuit configured to hold the voltage signal,
wherein generation of the first correction signal and generation of the second correction signal are performed by the hold circuit holding the voltage signal, and
wherein a time from when the switch element switches from the off state to the on state by supplying the driving signal to when the hold circuit holds the voltage signal is shorter in the generation of the second correction signal than in the generation of the first correction signal.

11. The system according to claim 9,
wherein the apparatus further comprises:
a switch element, one terminal of which is connected to the conversion element and the other terminal of which is connected to the reading unit; and
a driving unit configured to supply, to the switch element, a driving signal for switching on and off states of the switch element,
wherein the reading unit includes:
an amplification circuit configured to convert the charge accumulated in the conversion element into a voltage signal; and
a hold circuit configured to hold the voltage signal,
wherein generation of the first correction signal and generation of the second correction signal are performed by the hold circuit holding the voltage signal, and
wherein a time from when the switch element switches from the on state to the off state by supplying the driving signal to when the hold circuit holds the voltage signal is shorter in the generation of the second correction signal than in the generation of the first correction signal.

12. The system according to claim 9,
wherein, in the apparatus, after the transmission of the permission signal, the reading unit generates a first radiation signal by reading a charge accumulated in the conversion element based on the emission of the radiation during the first reading time or generates a second radiation signal by reading a charge accumulated in the conversion element based on the emission of the radiation during the second reading time, and
wherein, in the apparatus, the generation unit operates in a first offset imaging mode for generating image data using the first radiation signal and the first correction signal, and a second offset imaging mode for generating image data using the second radiation signal and the second correction signal.

13. The system according to claim 12, wherein, in the apparatus, the reading unit controls the first and second reading times so that a time from when the communication unit transmits the permission signal to when the generation unit generates the image data is same in the first and second offset imaging modes.

14. The system according to claim 12,
wherein, in the apparatus, the reading unit generates a third correction signal by reading a charge accumulated in the conversion element during the second reading time before the transmission of the permission signal, and
wherein, in the apparatus, the generation unit operates in a third offset imaging mode for generating image data using the second radiation signal, the second correction signal, and the third correction signal.

15. The system according to claim 14, wherein, in the apparatus, the reading unit reads the charge accumulated in the conversion element so that the accumulated charge is a charge accumulated during a first accumulation time or a second accumulation time shorter than the first accumulation time.

16. The system according to claim 15, wherein, in the apparatus, the reading unit controls the first and second accumulation times and the first and second reading times so that a time from when the communication unit transmits the permission signal to when the generation unit generates the image data is same in the first and third offset imaging modes.
